(19) United States
(12) Patent Application Publication
(10) Pub. No.: US 2014/0370992 A1
(43) Pub. Date: Dec. 18, 2014

(54) PLAYER SUBSTITUTION TO PRESERVE TEAM BALANCE

(71) Applicant: International Business Machines Corporation, Armonk, NY (US)

(72) Inventors: Gary D. Cudak, Creedmoor, NC (US); Christopher J. Hardee, Raleigh, NC (US); Randall C. Humes, Raleigh, NC (US); Adam Roberts, Moncure, NC (US)

(21) Appl. No.: 13/920,105

(22) Filed: Jun. 18, 2013

(51) Int. Cl. A63F 13/00

(52) U.S. Cl. CPC A63F 13/00
USPC 463/43

(57) ABSTRACT

Exemplary embodiments determine a type, and a status of a first character included in a group of characters participating in a gaming session. Exemplary embodiments determine a goal of the group of characters. Exemplary embodiments determine an environment of the group of characters. Exemplary embodiments determine a balance of a type of characters required to achieve the goal. Exemplary embodiments determine if the first character is available for continued participation in the gaming session. Exemplary embodiments respond to the determination that the first character is not available for continued participation in the gaming session, by identifying a first computer controlled character to replace the first character. Exemplary embodiments determine replace the first character with the identified first computer controlled character.

### FIELD OF THE INVENTION

The present invention relates generally to the field of gaming, and more particularly to substituting computer controlled players for human players to maintain team balance.

### BACKGROUND OF THE INVENTION

A multiplayer online game is a multiplayer video game which can be played via a game server over the internet, with other players around the world. A massively multiplayer online game (also called MMO and MMOG) is a multiplayer video game which is capable of supporting large numbers of players simultaneously. By necessity, they are played on the Internet. Many games have at least one persistent world; however others just have large numbers of players competing at once in one form or another without any lasting effect to the world at all. Multiplayer online game games differ from MMOGs in that they do not create a persistent world, but create a playing arena for the purpose of a single game or round. In other words, they rely on a game listen server used only for that round, and there can be numerous servers all around the world. MMOGs on the other hand, rely on dedicated servers, as these games must be running continuously.

Games that support and promote cooperative play are rapidly increasing in popularity. However, as the number players playing cooperatively have increased, so has the complexity of player interaction and interdependence during gaming sessions. For example, a given group of players often has players with assigned roles. As such the loss of one or more players from the group can be very detrimental to the ability of the group to perform various tasks within the game.

### SUMMARY

Embodiments of the present invention provide a system, method, and program product for maintaining gaming conditions during a gaming session. Exemplary embodiments determine a type, and a status of a first character included in a group of characters participating in a gaming session. Exemplary embodiments determine a goal of the group of characters. Exemplary embodiments determine an environment of the group of characters. Exemplary embodiments determine a balance of a type of characters required to achieve the goal. Exemplary embodiments determine if the first character is available for continued participation in the gaming session. Exemplary embodiments respond to the determination that the first character is not available for continued participation in the gaming session, by identifying a first computer controlled character to replace the first character. Exemplary embodiments determine replace the first character with the identified first computer controlled character.

### BRIEF DESCRIPTION OF THE SEVERAL VIEWS OF THE DRAWINGS

FIG. 1 is a functional block diagram illustrating a gaming environment, in accordance with an embodiment of the present invention.

FIG. 2 illustrates operational steps of a player substitution program, on a computing device within the gaming environment of FIG. 1, in accordance with an embodiment of the present invention.

FIG. 3 depicts a block diagram of components of the gaming device, and the computing device executing the player substitution program, in accordance with an embodiment of the present invention.

### DETAILED DESCRIPTION

Many gaming systems offer a variety of computer controlled characters that can be substituted for a missing member of a group of players. The computer controlled character can be tailored to mimic the average playing style of a given character. However, these computer controlled characters are often limited in their effectiveness since the play style or role of any given team member often changes during game play, i.e., human players typically adapt to changes in the game environment and the actions of other players. In addition, the generation of a computer controlled character that is custom tailored to match a player can be computationally expensive since this type of computer controlled character can require regular updates to account for changes in player style.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

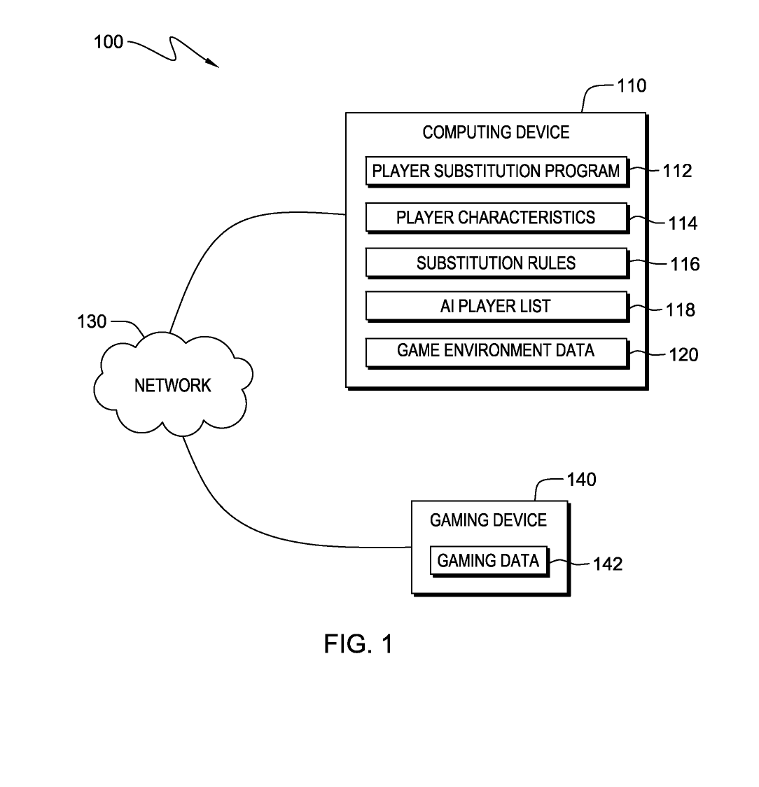

The present invention will now be described in detail with reference to the Figures. FIG. 1 is a functional block diagram illustrating a gaming environment, generally designated 100, in accordance with one embodiment of the present invention. Gaming environment 100 includes computing device 110 and gaming device 140, which are connected via network 130. Computing device includes player substitution program 112, player characteristics 114, substitution rules 116, artificial intelligence (AI) player list 118, and game environment data 120. Gaming device 140 includes gaming data 142.

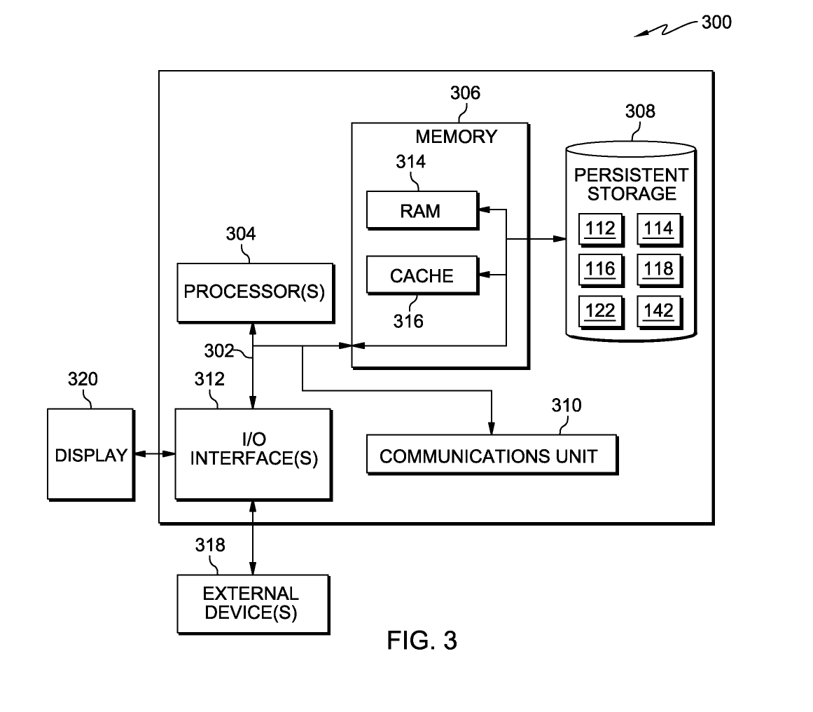

In various embodiments of the present invention, computing device 110 is computing device that can be a standalone device, a video game console, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to player substitution program 112, player characteristics 114, substitution rules 116, AI player list 118, and game environment data 120, and is capable of executing player substitution program 112. Computing device 110 may include internal and external hardware components, as depicted and described in further detail with respect to FIG. 3.

In various embodiments of the present invention, gaming device 140 is a computing device that can be a standalone device, a video game console, a server, a laptop computer, a tablet computer, a netbook computer, a personal computer (PC), or a desktop computer. In another embodiment, gaming device 140 represents a computing system utilizing clustered computers and components to act as a single pool of seamless resources. In general, gaming device 140 can be any computing device or a combination of devices capable of passing gaming information, included in gaming data 142, to computing device 110. Gaming device 140 may include internal and external hardware components, as depicted and described in further detail with respect to FIG. 3.

In this exemplary embodiment, player substitution program 112, player characteristics 114, substitution rules 116, AI player list 118, game environment data 120, and gaming data 142 are respectively stored on computing device 110 and gaming device 140. However, in other embodiments, player substitution program 112, player characteristics 114, substitution rules 116, AI player list 118, game environment data 120, and gaming data 142 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, gaming device 140 and player substitution program 112, player characteristics 114, substitution rules 116, AI player list 118, game environment data 120, and gaming data 142 in accordance with a desired embodiment of the present invention.

In an exemplary embodiment, computing device 110 acts as a host server for massively multiplayer online game (also called MMO and MMOG) sessions. Gaming device 140 sends the gaming information of a given individual player, included in gaming data 142, to player substitution program 112, which is executing on computing device 110.

In an exemplary embodiment, player substitution program 112 monitors the activity of the human player to determine if the player is available. If player substitution program 112 determines that the player is not available, then player substitution program 112 accesses the information included in player characteristics 114 and game environment data 120. Player substitution program 112 analyzes the received gaming information, the information included in player characteristics 114, and the information included in game environment data 120 by applying rules, included in substitution rules 116. Based on the results of the analysis, player substitution program 112 selects an appropriate AI player from a list of possible AI players, included in AI player list 118. Player substitution program 112 then substitutes the selected AI player for the human player, who is unavailable, operates gaming device 140. Player substitution program 112 then monitors the gaming environment for the return of the human player, i.e., if the human player becomes available. If the human player becomes available, then player substitution program 112 substitutes the human player for the AI player.

In an exemplary embodiment, player characteristics 114, includes information about the playing style and pattern of a human player. Player characteristics 114 is updated, by player substitution program 112, with the information received from gaming device 140, i.e., the information included in gaming data 142. The information included in player characteristics 114 includes information specifying the playing style of the human player in various scenarios. For example, the player may have different playing styles used for open grassy type terrain where movement is not limited as opposed to mountainous type terrain where the movement of the player's avatar is very limited. In another example, player characteristics 114 includes the preferred attack and defensive patterns used by the player for a particular enemy type. The information included in player characteristics 114 also includes information regarding specific roles that the user may perform for the group. For example, a particular player may favor the role of a healer in certain scenarios and the role of a tank, i.e., a close range brawler, in others. The information included in player characteristics 114 also includes specifics regarding the attributes of the player's avatar, e.g., the avatar's level. The information included in player characteristics 114 also includes specifics regarding the criteria that a player uses when changing playing style. For example, if a player consistently changes to long range attacks when their avatar's health points are low, then that information would be included in player characteristics 114.

In an exemplary embodiment, substitution rules 116 includes a set of rules to match a given unavailable player to an AI player. The rules take into account the information included in player characteristics 114 and game environment data 120. The rules identify the gaming environment and the playing style most often utilized by the human player for the given set of circumstances. The rules are applied, by player substitution program 112, to determine the most appropriate computer controlled player to be used as a substitute for a player that is unavailable. For example, a group of players is currently exploring a wooded region. The human player X is low on health. The rules in substitution rules 116 identify that in a wooded environment player X preferentially takes on the role of a tank. However, the rules in substitution rules 116 also identify that if player X is low on low on health, then player X preferentially switches to either a bowman class and uses long range attacks or switches to a healer class and heals the avatar's wounds. Given the wooded environment long range bow attacks would be ineffective. Therefore, the rules dictate that player X is replaced with a computer controlled player that primarily performs the functions of a healer.

Typically, a new analysis is performed, by player substitution program 112, whenever there is a substantial change in the environment of the player's avatar or in the status of the avatar. A substantial change is a change which could have a noticeable impact on the effectiveness of a given computer controlled player. For example, in continuation with the above example, after player X was substituted, by player substitution program 112, with an appropriate healer class computer controlled player, the healer class computer controlled player heals the avatar of player X. Based on the new circumstance, the rules now determine that the healer class computer controlled player be substituted with a tank class computer controlled player. Therefore, a tank class computer controlled player is matched up, by player substitution program 112, with the playing style of player X and is substituted for the healer class computer controlled player. In continuation with the example, the group of players leaves the wooded region and enters an open grassy area. Player substitution program 112 applies the rules in, substitution rules 116, and determines that based on the new circumstances, player X preferentially changes to a ranger class, which has increased speed and mobility on open ground. Player substitution program 112 matches the playing style of player X to a ranger class computer controlled player and substitutes the ranger class computer controlled player for the tank class computer controlled player.

In a last example, the group changes their quest from the “blackened scrolls” to the “yellowed horns” quest. A change in quest is considered a substantial change, therefore player substitution program 112 applies the rules included in substitution rules 116 to determine the most appropriate computer controlled player to use as a substitute for player X. The “yellowed horns” quest requires that the group include the following avatar classes: a tank, a magic user, a bowman, a healer, and two thieves in order to succeed. The other members of the group satisfy all of the required character classes except one of the thief classes. Therefore, the rules included in substitution rules 116 dictate that the computer controlled player of player X be a thief class computer controlled player.

In an exemplary embodiment, AI player list 118, includes a group of pre-generated computer controlled players, i.e., artificial intelligence (AI) players. In one embodiment, a computer controlled player takes control of a given player's avatar in the event of that player being unavailable. In another embodiment, the avatar of the unavailable player is duplicated and the duplicate, under control of the computer controlled player is substituted for the unavailable player. In another embodiment, a substitute avatar is generated that has similar attributes, e.g. level, equipment, ability etc., to the player's avatar. The substitute avatar, under control of the computer controlled player is substituted for the unavailable player. The list of computer controlled players includes players corresponding to the various classes available in a given game. Each class also includes several variations of playing style for the given class. For example, a player with a low level would not be as likely to attack a higher level opponent without waiting for an opening. Therefore, while a tank class would primarily be a close range fighter; there would still be several levels of aggressiveness.

In an exemplary embodiment, game environment data 120 includes information such as the gaming terrain, opponents, missions and quests in progress, and the requirements needed to achieve a mission or quest that is currently in progress. Game environment data 120 is updated, by player substitution program 112, with the information received from gaming device 140, i.e., the information included in gaming data 142. For example, a quest for “purple scrolls” requires a team of players with two tanks, a magic user, a bowman, and a healer in order to succeed. The avatar roles that the group must fill, i.e. the two tanks, the magic user, the bowman, and the healer, would all be included in game environment data 120 as part of the requirements for the “purple scrolls” quest. In certain embodiments, where groups of players, i.e., teams, compete with one another, game environment data 120 can also include information about the groups themselves. For example, game environment data 120 can include the average level for the players of a certain group or the average success rate of a particular attack pattern.

In an exemplary embodiment, gaming data 142 includes gaming information that is generated by individual players as well as certain group information. Gaming data 142 includes information such as the recent activity of a given player as well as group information such as a selected quest the group is attempting to complete. Gaming data 142 also includes specific information regarding the avatar of the player operating gaming device 140, e.g., avatar level, status information etc. The information included in gaming data 142 is passed to computing device 110 and used to populate player characteristics 114 and game environment data 120. The recent activity of a player can include actions which facilitate the efforts of the group as well as actions which inhibit the activities of the group, e.g., griefing. Griefing is when a player deliberately acts in a manner to prevent their group from achieving a goal. For example, a player may attack their teammates in order to advance the efforts of another competing team. A player who is griefing is determined by the rules, included in substitution rules 116, to be unavailable.

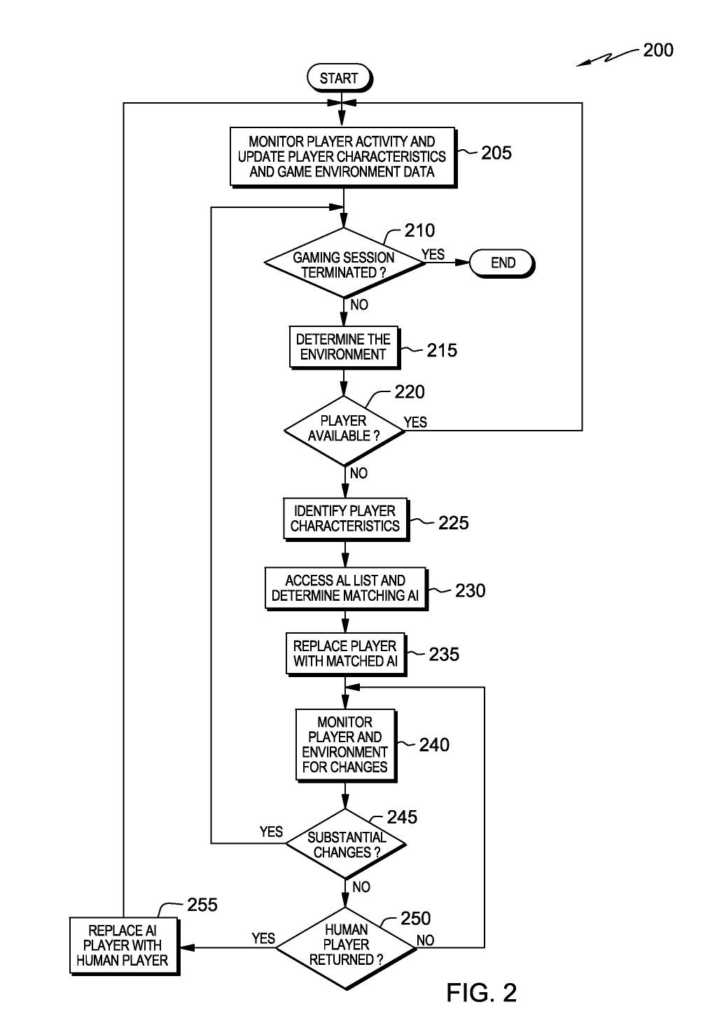

FIG. 2 is a flow chart, 200, illustrating the operational steps of player substitution program 112 executing on computing device 110, in accordance with an exemplary embodiment.

In step 205, player substitution program 112 monitors the activity of a group players participating in a gaming session and the game environment information and updates player characteristics and game environment data accordingly, included in player characteristics 114 and game environment data 120 respectively. The respective gaming devices of the various players included in the group players send respective gaming information, included in respective gaming data 142, to player substitution program 112. Player substitution program 112 then saves the received information to player characteristics 114 and game environment data 116 respectively.

In decision step 210, player substitution program 112 determines if the gaming session has been terminated. A gaming session is determined to be terminated if all of the group members are not available. If the gaming session has been terminated (decision step 210, yes branch), then player substitution program 112 ceases execution for that gaming session. If the gaming session has not been terminated (decision step 210, no branch), then player substitution program 112 proceeds to step 215.

In step 215, player substitution program 112 determines the environment of the group of players. Player substitution program 112 accesses game environment data 120 and identifies the terrain of the group and the current status of the group. For example, the group is in a desert and there are no nearby opponents.

In decision step 220, player substitution program 112 determines if the player, operating a given gaming device, is available. If the player is actively participating in the gaming session, and in a manner that is not considered griefing, then the player is determined to be available (decision step 220, yes branch) and player substitution program 112 proceeds to step 205. If the player is not actively participating in the gaming session or is acting in a manner that is not considered griefing, then the player is determined to be not available (decision step 220, no branch) and player substitution program 112 proceeds to step 225. In some situations, a player losing connectivity, e.g., the player loses internet connection, then the player is also considered not available.

In step 225, player substitution program 112 using the rules included in substitution rules 116, accesses player characteristics 114 and game environment data 120, and identifies the unavailable player's characteristics, i.e., their playing style etc. for the particular game scenario. For example, a player is often very aggressive and takes on the role of a tank when playing in confined conditions. The group is currently exploring a dungeon. Therefore, using the rules included in substitution rules 116 player substitution program 112 determines that the player characteristics to be an aggressive tank class.

In step 230, player substitution program 112 accesses AI player list 118 and matches the determined player characteristics to an appropriate computer controlled player, i.e., an AI player. In continuation with the previous example, a tank class computer controlled player with a high level of aggression would be matched to the determined player characteristics. Then in step 235, player substitution program 112 substitutes the tank class computer controlled player for the unavailable player.

In step 240, player substitution program 112 accesses player characteristics 114 and game environment data 120 and monitors the information they include for changes. For example a change can be the group leaving one area and entering another. Another change can be a status ailment being inflicted on a player in the group, e.g., the player's avatar is poisoned.

In decision step 245, player substitution program 112 applies the rules included in substitution rules 116 and determines if there are any changes that would be considered substantial, i.e., changes that would dictate a change in the computer controlled player. For example, a battle is going very badly for a group of players, three of the players are nearly out of life points, therefore player substitution program 112 determines that there has been a substantial change in the environment. In another example, a member of the group leaves to scout a short distance ahead. Player substitution program 112, determines that this is not a substantial change. If there has been a substantial change (decision step 245, yes branch), then player substitution program 112 proceeds to step 210. For example, the game session is terminated. Player substitution program 112 determines that the termination of a gaming session is a substantial change and proceeds to step 210. If there has not been a substantial change (decision step 245, no branch), then player substitution program 112 proceeds to decision step 250.

In decision step 250, player substitution program 112 determines if the human player has returned, i.e., has become available. If the player has become available (decision step 250, yes branch), then player substitution program 112 proceeds to step 255 and replaces the computer controlled player, i.e., the AI player, with the previously unavailable human player. If the player has not become available (decision step 250, no branch), then player substitution program 112 proceeds to step 240.

In some embodiments, player substitution program 112 can select various computer controlled players based on the playing ability of a given player. A replacement for an unavailable player is selected based, in part, on the playing ability of the player. The computer controlled player would therefore be selected such that the skill level would not be better than the player that is replaced. Such an approach could help deter deliberate replacement of a player in favor of a superior computer controlled player.

FIG. 3 depicts a block diagram, 300, of components of computing device 110 and gaming device 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 and gaming device 140 include respective communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Player substitution program 112, player characteristics 114, substitution rules 116, AI player list 118, game environment data 120, and gaming data 142 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of gaming device 140. In these examples, communications unit 310 includes one or more network interface cards. Communications unit 310 may provide communications through the use of either or both physical and wireless communications links. Player substitution program 112, player characteristics 114, substitution rules 116, AI player list 118, game environment data 120, and gaming data 142 may be downloaded to persistent storage 308 through communications unit 310.

I/O interface(s) 312 allows for input and output of data with other devices that may be connected to computing device 110. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., player substitution program 112, player characteristics 114, substitution rules 116, AI player list 118, game environment data 120, and gaming data 142, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of maintaining gaming conditions during a gaming session, the method comprising:
a computer determining a type, and a status of a first character included in a group of characters participating in a gaming session;
the computer determining a goal of the group of characters;
the computer determining an environment of the group of characters;
the computer determining a balance of a type of characters required to achieve the goal;
the computer determining if the first character is available for continued participation in the gaming session;
the computer responsive to the determination that the first character is not available for continued participation in the gaming session, the computer identifying a first computer controlled character to replace the first character; and
the computer replacing the first character with the identified first computer controlled character.

2. The method of claim 1, the method further comprising:
the computer determining if there has been a change in the gaming session;
the computer responsive to the determination that there has been a change in the gaming session, the computer identifying a second computer controlled character to replace the first computer controlled character; and
the computer replacing the first computer controlled character with the identified second computer controlled character.

3. The method of claim 1, wherein the replacement of the first character with the first computer controlled character conserves the balance of the type of characters required to achieve the goal of the group of characters.

4. The method of claim 2, wherein the replacement of the first computer controlled character with the second computer controlled character conserves the balance of the type of characters required to achieve the goal of the group of characters.

5. The method of claim 1, wherein the type of a character is defined by at least one of an attribute possessed by a character, and an action to be performed by the character.

6. The method of claim 5, wherein the action to be performed by the type of character supports one or more actions performed by one or more types of characters included in the group of characters.

7. The method of claim 2, wherein the first computer controlled character and the second computer controlled character both perform actions, as needed, that support one or more actions performed to achieve the goal of the group of characters.

8. The method of claim 1, wherein the step of the computer responsive to the determination that the first character is not available for continued participation in the gaming session, the computer identifying a first computer controlled character to replace the first character includes:
the computer identifying a first computer controlled program based on at least one of the type of the first character, the status of the first character, the goal of the group of characters, the environment of the group of characters, the balance of the type of characters required to achieve the goal, the type of the second character, and the status of the second character.

9. The method of claim 2, wherein the step of the computer determining if there has been a change in the gaming session includes:
the computer determining if there has been a change in at least one of the role of the first computer controlled character, the status of the first computer controlled character, the goal of the group of characters, the environment of the group of characters, the balance of the type of characters required to achieve the goal, the type of the second character, and the status of the second character.

10. The method of claim 2, wherein the step of the computer responsive to the determination that there has been a change in the gaming session, the computer identifying a second computer controlled character to replace the first computer controlled character includes:
the computer identifying a second computer controlled character based on at least one of the type of the first computer controlled character, the status of the first computer controlled character, the goal of the group of characters, the environment of the group of characters, the balance of the type of characters required to achieve the goal, the type of the second character, and the status of a second character.

11. A computer program product for maintaining gaming conditions during a gaming session, the computer program product comprising:
one or more computer-readable storage media and program instructions stored on the one or more computer-readable storage media, the program instructions comprising:
program instructions to determine a goal of the group of characters;
program instructions to determine an environment of the group of characters;
program instructions to determine a balance of a type of characters required to achieve the goal;
program instructions to determine if the first character is available for continued participation in the gaming session;
program instructions to respond to the determination that the first character is not available for continued participation in the gaming session, by identifying a first computer controlled character to replace the first character; and
program instructions to replace the first character with the identified first computer controlled character.

12. The computer program product of claim 11, the program instructions further comprising:
program instructions to determine if there has been a change in the gaming session;
program instructions to respond to the determination that there has been a change in the gaming session, by identifying a second computer controlled character to replace the first computer controlled character; and
program instructions to replace the first computer controlled character with the identified second computer controlled character.

13. The computer program product of claim 11, wherein the replacement of the first character with the first computer controlled character conserves the balance of the type of characters required to achieve the goal of the group of characters.

14. The computer program product of claim 12, wherein the replacement of the first computer controlled character with the second computer controlled character conserves the balance of the type of characters required to achieve the goal of the group of characters.

15. The computer program product of claim 11, wherein the type of a character is defined by at least one of an attribute possessed by a character, and an action to be performed by the character.

16. The computer program product of claim 15, wherein the action to be performed by the type of character supports one or more actions performed by one or more types of characters included in the group of characters.

17. The computer program product of claim 12, wherein the first computer controlled character and the second computer controlled character both perform actions, as needed, that support one or more actions performed to achieve the goal of the group of characters.

18. The computer program product of claim 11, wherein the program instructions to respond to the determination that the first character is not available for continued participation in the gaming session, by identifying a first computer controlled character to replace the first character further comprise:
program instructions to identify a first computer controlled program based on at least one of the type of the first character, the status of the first character, the goal of the group of characters, the environment of the group of characters, the balance of the type of characters required to achieve the goal, the type of the second character, and the status of the second character.

19. The computer program product of claim 12, wherein the program instructions to determine if there has been a change in the gaming session further comprise:
program instructions to determine if there has been a change in at least one of the role of the first computer controlled character, the status of the first computer controlled character, the goal of the group of characters, the environment of the group of characters, the balance of the type of characters required to achieve the goal, the type of the second character, and the status of the second character.

20. The computer program product of claim 12, wherein the program instructions to respond to the determination that there has been a change in the gaming session, by identifying a second computer controlled character to replace the first computer controlled character further comprise:
program instructions to identify a second computer controlled character based on at least one of the type of the first computer controlled character, the status of the first computer controlled character, the goal of the group of characters, the environment of the group of characters, the balance of the type of characters required to achieve the goal, the type of the second character, and the status of a second character.
